(19) United States
(12) Patent Application Publication
(10) Pub. No.: US 2017/0186347 A1
(43) Pub. Date: Jun. 29, 2017

(54) MINE SITE VEHICLE MOUNTED SAFETY FLAG SYSTEM

(71) Applicant: Robert Garry Sorensen, Salmon Arm (CA)

(72) Inventor: Robert Garry Sorensen, Salmon Arm (CA)

(21) Appl. No.: 14/981,399

(22) Filed: Dec. 28, 2015

(30) Foreign Application Priority Data
Dec. 23, 2015 (CA) 2916226

(51) Int. Cl. G09F 17/00

(52) U.S. Cl. CPC G09F 17/00; G09F 2017/0075; G09F 2017/0083

(57) ABSTRACT

A vehicle mounted flag warning system for mine excavation sites, comprising: a) a base plate comprising a top side and a bottom side and including a plurality of mounting holes; b) an electric hydraulic piston device affixed to a top side of the base plate and engaged with a rotatable cam; d) a spring mounted flag rotatable affixed to the flag cam mount; and e) a switch in electrical communication with the electric hydraulic piston, wherein the flag is rotatably position vertically and rotatably position horizontally when the switch is toggled.

### FIELD OF THE INVENTION

The present disclosure is in the field of a flag safety system for vehicles used at a mining site.

### BACKGROUND OF THE DISCLOSURE

Mine sites are very dangerous working environments. Large machinery and vehicles are maneuvered around the mine site to transport ore. Utility vehicles and other smaller vehicles are also used for moving people, machines around the mine site. Dump trucks used at the mine site can be more than 7 meters tall and can transport loads in excess of 200 tonnes of ore and must be maneuvered carefully to avoid accidents at the mine site.

Utility vehicles and other smaller vehicles are required to display visible safety flags to be seen by larger vehicles and people around the site. This requires an operator of such a vehicle to exit the vehicle to orient the flag to a vertical position in a flag mount. This step of exiting the vehicle to position the safety flag is dangerous because the operator is now outside the vehicle and at greater risk of being injured by other vehicles.

It is therefore apparent that there exists a need for an flag safety system which can be operated from the cab of a vehicle without the operator exiting the vehicle to place the flag in a vertical position.

### SUMMARY OF THE INVENTION

A vehicle mounted flag warning system for mine excavation sites, comprising: a) a base plate comprising a top side and a bottom side and including a plurality of mounting holes; b) an electric hydraulic piston device affixed to the base plate and engaged with a rotatable cam, wherein the cam is affixed to a shaft at a first end, wherein the shaft is rotatably engaged with a flag cam mount at a second end, and wherein the first end and second end of the shaft are separated by a shaft collar; d) a spring mounted flag rotatable affixed to the flag cam mount; and e) a switch in electrical communication with the electric hydraulic piston, wherein the flag is rotatably position vertically and rotatably position horizontally when the switch is toggled.

A vehicle mounted flag warning system for mine excavation sites, comprising: a) a base plate comprising a top side and a bottom side and including a plurality of mounting holes; b) an electric motor affixed to a top side of the base plate comprising a drive shaft that is rotatably engaged with a flag cam mount or an electric motor with an electric motor drive shaft that is rotatably engaged with a 50:1 gear box and a gear box drive shaft rotatably engaged with a flag cam mount; c) a flag and a corresponding spring mounted flag pole rotatable affixed to the flag cam mount; and d) a switch in electrical communication with the electric hydraulic piston, wherein the flag is rotatably position vertically and rotatably position horizontally when the switch is toggled up and down.

### BRIEF DESCRIPTION OF THE DRAWINGS

FIG. 1 is a top view illustration of a vehicle mounted flag warning system 100 comprising an electric hydraulic piston 134, a flag 104 and a flag pole 106 rotatably affixed to a flat surface mount 130, whereby the flag is in a vertical position, and whereby the truck bed frame portion 154 is affixed to a bottom side of the base plate 120 and inserted in a bed rail channel 156 of a passenger's side truck bedrail 158 of a vehicle.

FIG. 2 is a top view illustration of a vehicle mounted flag warning system 200 comprising an electric hydraulic piston 134, a flag 104 and a flag pole 106 rotatably affixed to a flat surface mount 130, whereby the flag is in a horizontal position, whereby the truck bed frame portion 160 is affixed to a bottom side of the base plate 120 and inserted in a bed rail channel 162 of a driver's side truck bedrail 164 of a vehicle.

FIG. 3A is a top view illustration of a vehicle mounted flag warning system 500 comprising an electric motor 502, whereby the flag 104 and a corresponding spring mounted flag pole 106 are rotated vertically to be perpendicular to the base plate 520.

FIG. 3B is a top view illustration of a vehicle mounted flag warning system 600 comprising an electric motor 502, whereby the flag 104 and a corresponding spring mounted flag pole 106 are rotated vertically to be perpendicular to the base plate 602.

FIG. 3C depicts a vehicle mounted flag warning system 800 comprising an electric motor 802 affixed to the base plate 520 comprising a drive shaft 810 that is rotatably engaged with a flag cam mount 110 affixed to a drive shaft 810.

FIG. 4A is a top view illustration of a base plate 700 depicting base plates 120, 520 and 602 each independently comprising a plurality of central mounting holes 510 and perimeter mounting holes 604.

FIG. 4B is an illustration of a base plate 700, comprising a plurality of plurality of central mounting holes 510 and/or perimeter mounting holes 604, wherein the system is capable of being mounted on a rail 806 of a rooftop rack of a vehicle via mounting bracket 802.

FIG. 4C is an illustration of a base plate 700, comprising a plurality of plurality of central mounting holes 510 and/or perimeter mounting holes 604, wherein the system is capable of being mounted on a rail 902 of a rooftop rack or a side rail of a vehicle via mounting bracket 906.

FIG. 4D is an illustration of a base plate 700, comprising a plurality of plurality of central mounting holes 510 and/or perimeter mounting holes 604, wherein the system is capable of being mounted on a on a receiver hitch top plate 1002 of a receiver hitch accessory 1008.

### DETAILED DESCRIPTION OF THE EMBODIMENTS

The following is a detailed description of certain specific embodiments of the vehicle mounted flag warning systems disclosed herein. In this description reference is made to the drawings.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

### Introduction

In one aspect, disclosed herein is a vehicle mounted flag warning system for mine excavation sites, comprising: a) a base plate comprising a top side and a bottom side and including a plurality of mounting holes; b) a truck bed frame portion affixed to the base plate forming a 90 degree angle with the bottom side of the base plate, wherein the truck bed frame portion is capable of being inserted within a bed rail channel; c) an electric hydraulic piston device affixed to a top side of the base plate and engaged with a rotatable cam, wherein the cam is affixed to a shaft at a first end, wherein the shaft is rotatably engaged with a flag cam mount at a second end, and wherein the first end and second end of the shaft are separated by a shaft collar; d) a spring mounted flag rotatable affixed to the flag cam mount; and e) a switch in electrical communication with the electric hydraulic piston, wherein the flag is rotatably position vertically and rotatably position horizontally when the switch is toggled, wherein the system further comprises a safety cover that is affixed to the base plate and shielding the electric hydraulic piston and the rotatable cam.

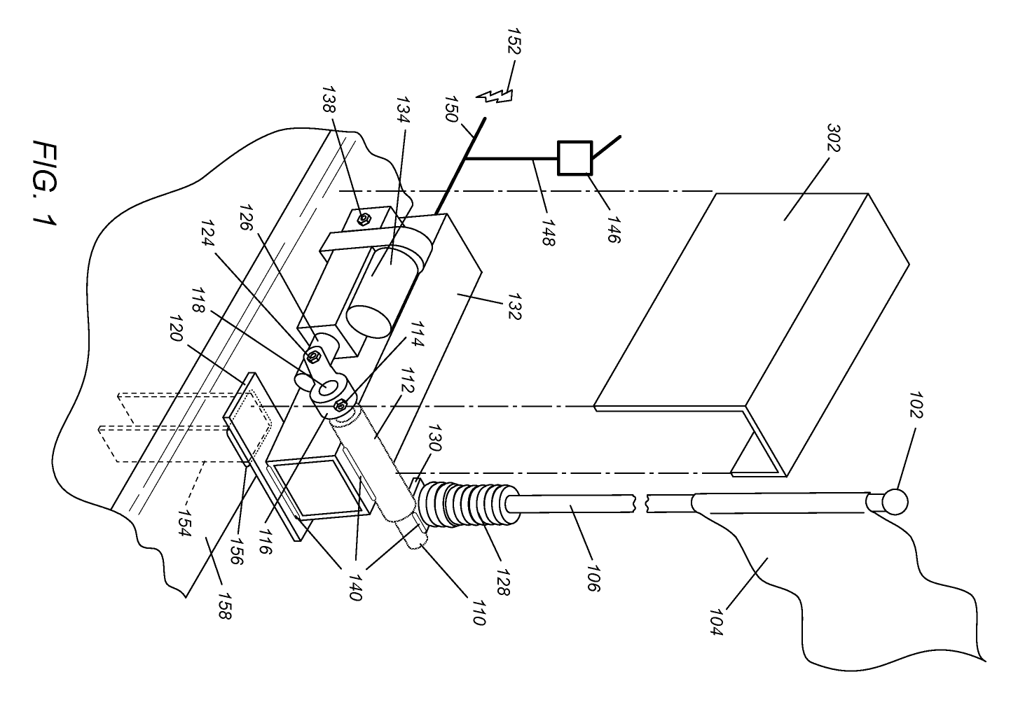

Turning to the drawings, FIG. 1 illustrates a vehicle mounted flag warning system 100 comprising an electric hydraulic piston 134, a flag 104 and a flag pole 106 rotatably affixed to a flag cam mount 110. In some embodiments, the flag 104 further comprises a safety light 102 affixed to the top of a flag pole. In some embodiments, the flag 104 further comprises a flag pole base mount spring 128 affixed to a flag cam mount 110 via flag fastener 108. FIG. 1 illustrates the vehicle mounted flag warning system 100 with the electric hydraulic piston 134 in a retracted position, which results in the flag cam mount 110 being positioned to provide a surface capable of supporting the flag pole 106 in a vertical position. The terminal end of the piston is affixed with freely rotating fastener 124 to the rotatable cam 116, whereby the rotatable cam 116 is rotatably attached to a shaft 118 at a first end with a fastener 114. The shaft 118 is rotatably held in place inside shaft collar 112 against base plate 120 atop the frame 132, wherein the electric hydraulic piston 134 is affixed to the frame 132 via electric hydraulic piston fastener 138. In some embodiments, the shaft collar 112 is affixed to the frame 132 via shaft collar welds 140. The shaft 118 is rotatably engaged with a flag cam mount 110 at a second end of the shaft 118 whereby when the electric hydraulic piston 134 is in the retracted position the flat surface mount 130 of flag cam mount 110 is oriented to horizontally to base plate 120. Moreover, the system is equipped with an AC power cord or a power cable 150 in electrical communication with the vehicle's power supply 152 and in both instances the operation of the system is controlled with a switch 146 via switch cable 148, whereby the switch 146 positioned in the vehicle's cab near the driver that is capable of completing the circuit for providing power and interrupting power to the vehicle mounted flag warning system 100. In this aspect, the operator switches the system “ON” via the switch and the electric hydraulic piston 134 moves to a retracted position 126 as depicted with FIG. 1. In some embodiments, the system further comprises that electrical power is provided by a power connection to a vehicle employing the flag warning system. In some embodiments, the flag is raised vertically and lowered to a horizontal position via the switch, which is in electrical communication with electrical power provided by a power connection to a vehicle.

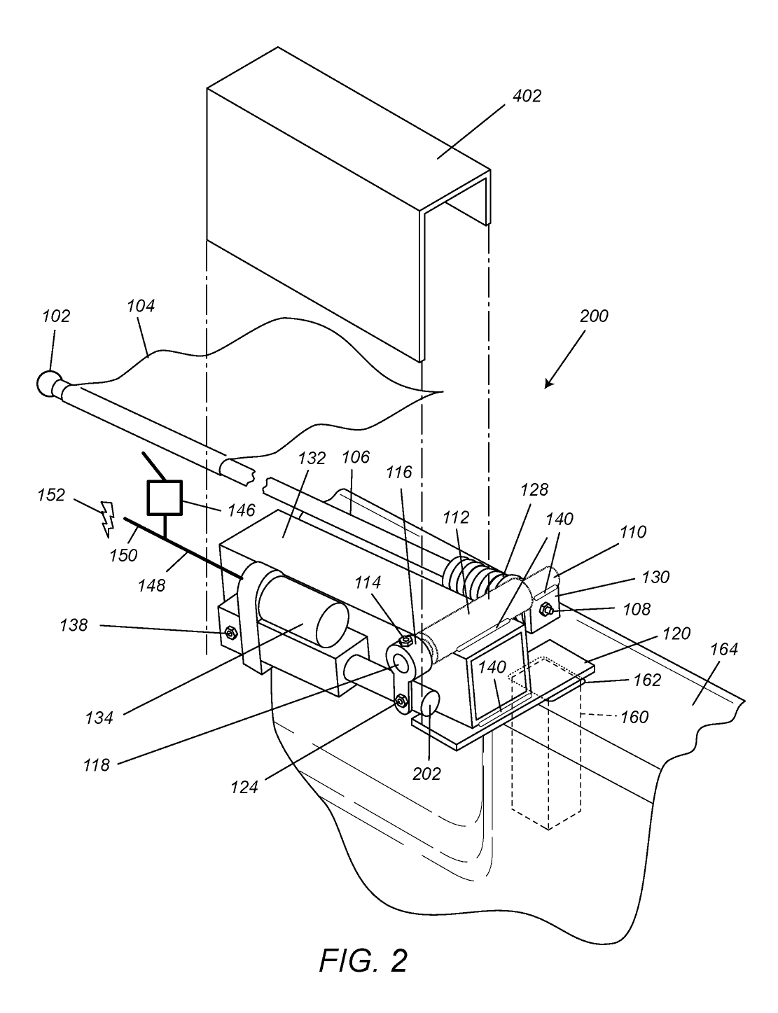

As depicted with FIG. 2 the electric hydraulic piston 134 in a fully extended position, which results in the flag cam mount 110 being positioned to provide a flat surface mount 130 capable of supporting the flag pole 106 in a horizontal position. In this aspect, the operator switches the system “OFF” via the switch 146 and the electric hydraulic piston 134 moves to an extended position 202 as depicted with FIG. 2.

Referring to the drawings, FIG. 1 depicts the vehicle mounted flag warning system 100, whereby the truck bed frame portion 154 is affixed to a bottom side of the base plate 120 and inserted in a bed rail channel 156 on a passenger's side of a vehicle. FIG. 2 depicts the vehicle mounted flag warning system 200 whereby the truck bed frame portion 160 is affixed to a bottom side of the base plate 120 and inserted in a bed rail channel 162 on a driver's side of a vehicle. The base plate 120 with the truck bed frame portions 154 and 122 affixed to the base plate forming a 90 degree angle with the bottom side of the base plate, wherein the truck bed frame portion 122 is capable of being inserted within a bed rail channel as illustrated with FIGS. 1 and 2. In some embodiments, the system further comprises that the truck bed frame portion is affixed to a bottom side of the base plate for inserting the truck bed frame portion in a bed rail channel on a passenger's side of a vehicle. In some embodiments, the system further comprises that the truck bed frame portion is affixed to a bottom side of the base plate for inserting the truck bed frame portion in a bed rail channel on a driver's side of a vehicle. The system further comprises a safety cover 302 that is affixed to the base plate 120 and shielding the electric hydraulic piston 134 and the rotatable cam 116.

In another aspect, disclosed herein is a vehicle mounted flag warning system for mine excavation sites, comprising: a) a base plate comprising a top side and a bottom side and including a plurality of mounting holes; c) an electric motor affixed to a top side of the base plate comprising a drive shaft that is rotatably engaged with a flag cam mount or an electric motor with an electric motor drive shaft that is rotatably engaged with a 50:1 gear box and a gear box drive shaft rotatably engaged with a flag cam mount; d) a flag and a corresponding spring mounted flag pole rotatable affixed to the flag cam mount; and e) a switch in electrical communication with the electric hydraulic piston, wherein the flag is rotatably position vertically and rotatably position horizontally when the switch is toggled up and down, wherein the system further comprises a safety cover that is affixed to the base plate and shielding the electric motor and the electric motor drive shaft or the electric motor, the electric motor drive shaft and the 50:1 gear box.

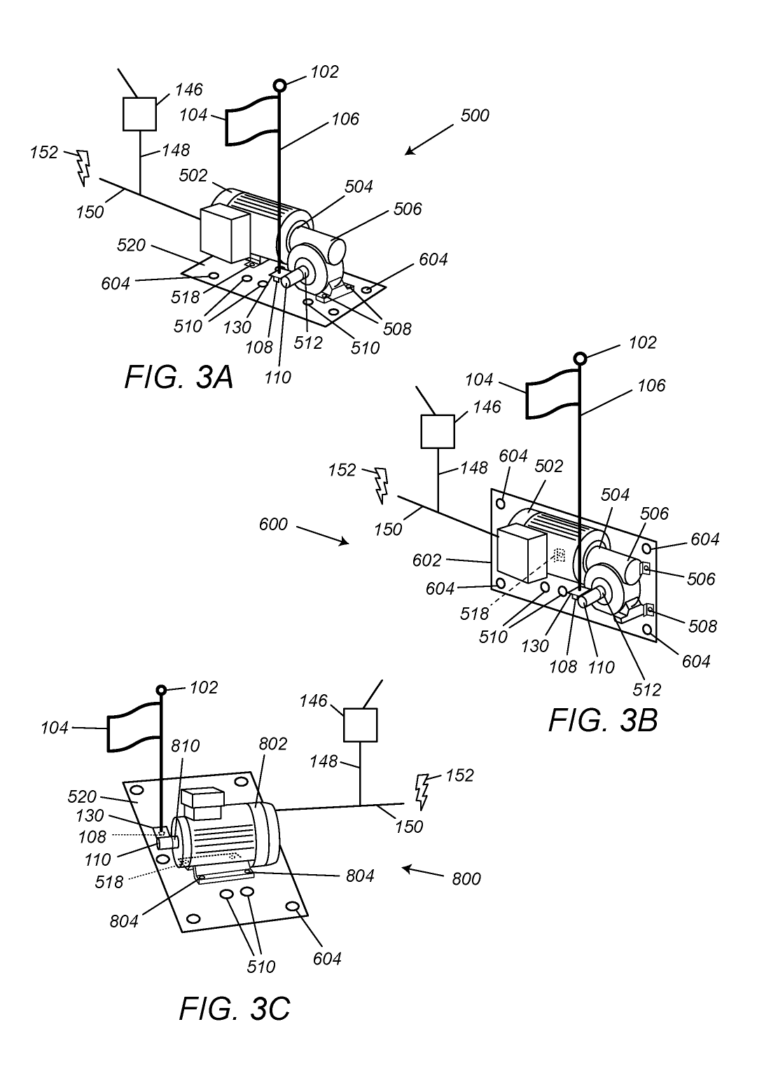

Referring to the drawings, FIG. 3A, depicts a vehicle mounted flag warning system 500 comprising an electric motor 502, whereby the flag 104 and a corresponding spring mounted flag pole 106 are rotated vertically to be perpendicular to the base plate 520. The vehicle mounted flag warning system 500 is designed to be affixed to a horizontal mounting position on a vehicle via base plate 520. FIG. 3B depicts a vehicle mounted flag warning system 600 comprising an electric motor 502, whereby the flag 104 and a corresponding spring mounted flag pole 106 are rotated vertically to be perpendicular to the base plate 602. The vehicle mounted flag warning system 600 is designed to be affixed to a vertical mounting position on a vehicle via base plate 520. The vehicle mounted flag warning systems 500 and 600 comprise electric motor 502, which is mounted to base plate 520, via fasteners 518 and base plate mounting holes 510. The electric motor 502 with an electric motor drive shaft 504 that is rotatably engaged with a 50:1 gear box 506 and a gear box drive shaft 512 rotatably engaged with a flag cam mount 514 affixed to the gear box drive shaft 512. 50:1 gear box 506 is affixed to the base plate 520 via fasteners 508 and base plate mounting holes 510. FIG. 3C depicts a vehicle mounted flag warning system 800 comprising an electric motor 802 affixed to the base plate 520 comprising a drive shaft 810 that is rotatably engaged with a flag cam mount 808 affixed to the drive shaft 810. The vehicle mounted flag warning system 800 is designed to be affixed to a horizontal mounting position on a vehicle via base plate 520, via fasteners 804 and base plate mounting holes 510. In some embodiments, the electric motor is affixed to the base plate in a position whereby the flag and a corresponding spring mounted flag pole are rotated vertically to be perpendicular to the base plate, wherein the system is mounted to a horizontal portion of a vehicle. In some embodiments, the electric motor is affixed to the base plate in a position whereby the flag and a corresponding spring mounted flag pole are rotated vertically to be parallel to the base plate, wherein the system is mounted to a vertical portion of a vehicle. Moreover, as depicted with FIG. 1 the vehicle mounted flag warning systems 500, 600 and 800 are equipped with an AC power cord or a power cable 150 in electrical communication with the vehicle's power supply 152 and in both instances the operation of the system is controlled with a switch 146 positioned in the vehicle's cab near the driver that is capable of completing the circuit for providing power and interrupting power to the vehicle mounted flag warning systems 500, 600 and 800. In this aspect, the operator switches the system “ON” via the switch and the electric motor rotates the flag 104 and corresponding flag pole 106 to either the horizontal position or the vertical position. In some embodiments, a signal is sent to the electric motor, which rotates the drive shaft through about a quarter revolution, and then stops. In some embodiments, the system further comprises that electrical power is provided by a power connection to a vehicle employing the flag warning system. In some embodiments, the flag is raised vertically and lowered to a horizontal position via the switch, which is in electrical communication with electrical power provided by a power connection to a vehicle. In some embodiments, the flag further comprises a safety light 102 affixed to the top of the flag pole. In some embodiments, the safety light 102 comprises wiring that is connected AC power cord or a power cable 150 in electrical communication with the vehicle's power supply 152 and in both instances the operation of the system is controlled with a switch 146. In some embodiments, the flag with a safety light as used in the mining industry at mine sites with smaller vehicles and is an all-purpose lighted warning whip with or without pigtail wiring and manufactured by Checkers® Industrial Safety Products (see www.checkersindustrial.com) or Gorilla Whips (see www.gorillawhips.com).

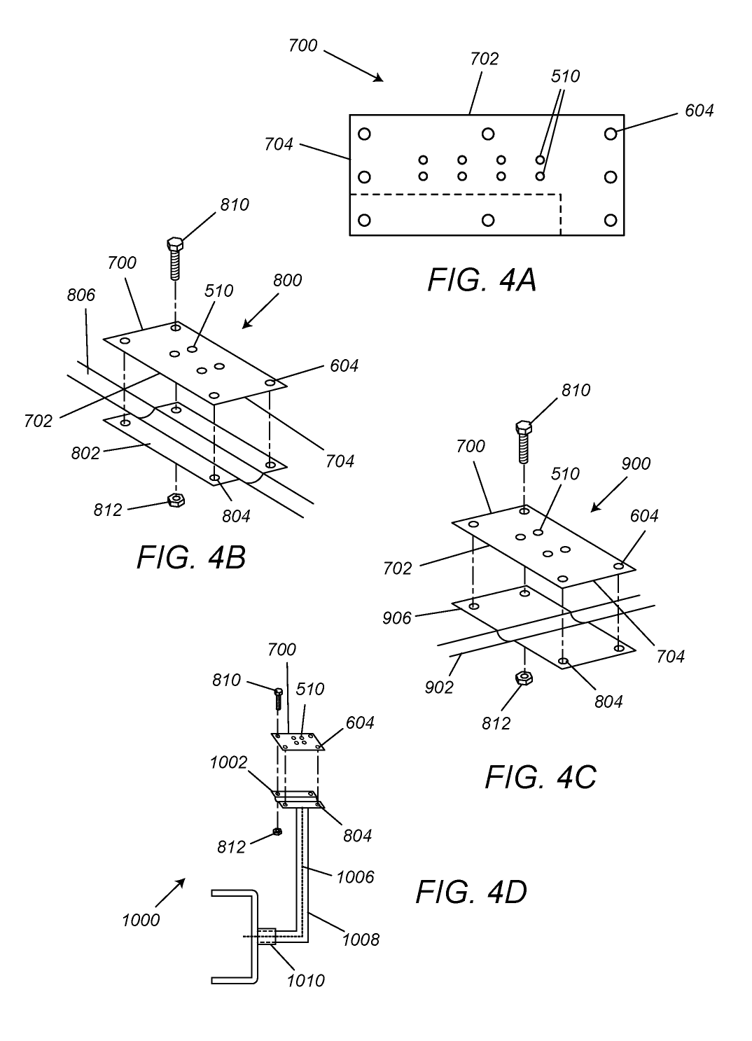

Referring to the drawings, FIG. 4A depicts base plate 700 depicting base plates 120, 520 and 602, wherein the base plate 700 comprises a plurality of central mounting holes 510 and perimeter mounting holes 604. In some embodiments, base plate 120 has an L-shape as illustrated with the dotted line cut out of FIG. 4A. In this aspect, the base plate 120 may used for the vehicle mounted flag warning system depicted with FIG. 1, illustrates that the truck bed frame portion 154 is affixed to a bottom side of the base plate 120 and inserted in a bed rail channel 156 of a passenger's side truck bedrail 158 of a vehicle. FIG. 2 depicts the vehicle mounted flag warning system 200 whereby the truck bed frame portion 160 is affixed to a bottom side of the base plate 120 and inserted in a bed rail channel 162 of a driver's side truck bedrail 164 of a vehicle. In some embodiments, the truck bed frame portion 154 and the truck bed frame portion 160 are absent with the vehicle mounted flag warning system 100 and 200 depicted with FIGS. 1 and 2, respectively. In some embodiments, the truck bed frame portion 154 and the truck bed frame portion 160 are absent which allows for the vehicle mounted flag warning system 100 and 200 to be affixed to a horizontal mounting position on a vehicle. In some embodiments, the base plates, truck bed frame portions, frame 132, shaft collar, etc are fabricated from steel, aluminum, titanium or combinations thereof In some embodiments, the base plates, truck bed frame portions, frame 132, and shaft collar are fabricated from steel, aluminum, titanium or combinations thereof and comprising a plurality of welds. Base plates 520 and 602 are depicted with FIG. 4A of base plate 700 having a base plate length 702 and base plate width 704. In some embodiments, the base plate length is between about 6 inches and about 18 inches and the base plate width is between about 3 inches and about 12 inches. In some embodiments, the base plates 520 and 602 are either rectangular or square. FIG. 4B is an illustration of a vehicle mounted flag warning system 800 with base plate 700, comprising a plurality of central mounting holes 510 and perimeter mounting holes 604, wherein the system is capable of being mounted on a rail 806 of a rooftop rack of a vehicle with at least one mounting bracket 802 via a plurality of mounting bolts 808 and nuts 810. FIG. 4C of a vehicle mounted flag warning system 900 with base plate 700, comprising a plurality of central mounting holes 510 and perimeter mounting holes 604, wherein the system is capable of being mounted on a rail 902 of a rooftop rack of a vehicle via mounting bracket 906. FIG. 4D is an illustration of a vehicle mounted flag warning system 1000 with base plate mount 700, comprising a plurality of central mounting holes 510 and perimeter mounting holes 604, wherein the system is capable of being mounted on a on a receiver hitch accessory top plate 1002 of a receiver hitch accessory 1008 mounted in a receiver hitch 1010 of a vehicle. The receiver hitch accessory 1008 comprises one or more receiver hitch accessory power wires 1006 capable of being in electrical communication with the vehicle and the devices described herein. In some embodiments, the system further comprises that the mounting holes are positioned at intervals around the perimeter of the base plate and in pairs evenly spaced at intervals in a center portion of the base plate. In some embodiments, the system further comprises that the mounting holes are positioned at intervals around the perimeter of the base plate and in pairs evenly spaced at intervals in a center portion of the base plate, wherein the system is capable of being mounted on a rail of a rooftop rack of a vehicle, on top of a receiver hitch, on a side portion of a vehicle's body or on a top portion of a vehicle's roof.

The presently disclosed vehicle mounted flag warning systems are not to be limited in scope by the specific embodiments described herein, which are intended as single illustrations of individual aspects of the presently disclosed devices and methods, and functionally equivalent devices, methods and components are within the scope of the presently disclosed vehicle mounted flag warning systems. Indeed, various modifications of the presently disclosed vehicle mounted flag warning systems, in addition to those shown and described herein will become apparent to those skilled in the art from the foregoing description and accompanying drawings. Such modifications are intended to fall within the scope of the appended claims.

What is claimed is:

1. A vehicle mounted flag warning system for mine excavation sites, comprising:
a) a base plate comprising a top side and a bottom side and including a plurality of mounting holes;
b) an electric hydraulic piston device affixed to a top side of the base plate and engaged with a rotatable cam, wherein the cam is affixed to a shaft at a first end, wherein the shaft is rotatably engaged with a flag cam mount at a second end, and wherein the first end and second end of the shaft are separated by a shaft collar;
c) a spring mounted flag rotatable affixed to the flag cam mount; and
d) a switch in electrical communication with the electric hydraulic piston, wherein the flag is rotatably position vertically and rotatably position horizontally when the switch is toggled.

2. A vehicle mounted flag warning system for mine excavation sites, comprising:
a) a base plate comprising a top side and a bottom side and including a plurality of mounting holes;
b) a truck bed frame portion affixed to the base plate forming a 90 degree angle with the bottom side of the base plate, wherein the truck bed frame portion is capable of being inserted within a bed rail channel;
c) an electric hydraulic piston device affixed to a top side of the base plate and engaged with a rotatable cam, wherein the cam is affixed to a shaft at a first end, wherein the shaft is rotatably engaged with a flag cam mount at a second end, and wherein the first end and second end of the shaft are separated by a shaft collar;
d) a spring mounted flag rotatable affixed to the flag cam mount; and
e) a switch in electrical communication with the electric hydraulic piston, wherein the flag is rotatably position vertically and rotatably position horizontally when the switch is toggled.

3. The vehicle mounted flag warning system of claim 2, wherein the system further comprises a safety cover that is affixed to the base plate and shielding the electric hydraulic piston and the rotatable cam.

4. The vehicle mounted flag warning system of claim 2, wherein the flag further comprises a safety light affixed to the top of a flag pole.

5. The vehicle mounted flag warning system of claim 2, wherein the system further comprises that electrical power is provided by a power connection to a vehicle employing the flag warning system.

6. The vehicle mounted flag warning system of claim 2, wherein the flag is raised vertically and lowered to a horizontal position via the switch, which is in electrical communication with electrical power provided by a power connection to a vehicle.

7. The vehicle mounted flag warning system of claim 2, wherein the system further comprises that the truck bed frame portion is affixed to a bottom side of the base plate for inserting the truck bed frame portion in a bed rail channel on a passenger's side of a vehicle.

8. The vehicle mounted flag warning system of claim 2, wherein the system further comprises that the truck bed frame portion is affixed to a second side of the base plate for inserting the truck bed frame portion in a bed rail channel on a driver's side of a vehicle.

9. A vehicle mounted flag warning system for mine excavation sites, comprising:
a) a base plate comprising a top side and a bottom side and including a plurality of mounting holes;
b) an electric motor affixed to a top side of the base plate comprising a drive shaft that is rotatably engaged with a flag cam mount or an electric motor with an electric motor drive shaft that is rotatably engaged with a 50:1 gear box and a gear box drive shaft rotatably engaged with a flag cam mount;
c) a flag and a corresponding spring mounted flag pole rotatable affixed to the flag cam mount; and
d) a switch in electrical communication with the electric hydraulic piston, wherein the flag is rotatably position vertically and rotatably position horizontally when the switch is toggled up and down.

10. The vehicle mounted flag warning system of claim 8, wherein the electric motor is affixed to the base plate in a position whereby the flag and a corresponding spring mounted flag pole are rotated vertically to be perpendicular to the base plate, wherein the system is mounted to a horizontal portion of a vehicle.

11. The vehicle mounted flag warning system of claim 8, wherein the electric motor is affixed to the base plate in a position whereby the flag and a corresponding spring mounted flag pole are rotated vertically to be parallel to the base plate, wherein the system is mounted to a vertical portion of a vehicle.

12. The vehicle mounted flag warning system of claim 8, wherein the system further comprises a safety cover that is affixed to the base plate and shielding the electric motor and the electric motor drive shaft or the electric motor, the electric motor drive shaft and the 50:1 gear box.

13. The vehicle mounted flag warning system of claim 8, wherein the flag further comprises a safety light affixed to the top of the flag pole.

14. The vehicle mounted flag warning system of claim 8, wherein the system further comprises that electrical power is provided by a power connection to a vehicle employing the flag warning system.

15. The vehicle mounted flag warning system of claim 8, wherein the flag is raised vertically and lowered to a horizontal position via the switch, which is in electrical communication with electrical power provided by a power connection to a vehicle.

16. The vehicle mounted flag warning system of claim 8, wherein the system further comprises that the mounting holes are positioned at intervals around the perimeter of the base plate and in pairs evenly spaced at intervals in a center portion of the base plate.

17. The vehicle mounted flag warning system of claim 8, wherein the system further comprises that the mounting holes are positioned at intervals around the perimeter of the base plate and in pairs evenly spaced at intervals in a center portion of the base plate, wherein the system is capable of being mounted on a rail of a rooftop rack of a vehicle, on top of a receiver hitch accessory, on a side portion of a vehicle's body or on a top portion of a vehicle's roof.
